(19) United States
(12) Patent Application Publication
(10) Pub. No.: US 2004/0248472 A1
(43) Pub. Date: Dec. 9, 2004

(54) Miniaturized connector

(76) Inventors: Akira Aso, Yokohama (JP); Masami Sasao, Kanagawa (JP); Kazuya Takahashi, Kanagawa (JP)

Correspondence Address: Robert J Zeitler, Molex Incorporated, 2222 Wellington Court, Lisle, IL, 60532, US

(21) Appl. No.: 10/496,823

(22) PCT Filed: Dec. 4, 2002
(86) PCT No.: PCT/US02/38847

(30) Foreign Application Priority Data
Dec. 7, 2001 (JP) 2001-373829

(51) Int. Cl. H01R 24/00

(52) U.S. Cl. 439/660

(57) ABSTRACT

The present invention is directed to an electrical connector having at least two terminals that are short-circuited to each other by the use of a continuous portion. The continuous portion is formed during the manufacturing process of the terminals, thereby simplifying short-circuiting of two or more terminals together.

### FIELD OF THE INVENTION

The present invention relates to short circuiting terminals of a connector, and in particular, to a miniaturized USB type connector having two of its terminals short circuited together which is used in equipment requiring a smaller connector, such as portable electronic equipment

### BACKGROUND OF THE INVENTION

A USB (Universal Serial Bus) connector is generally known. Recently, portable equipment, such as digital cameras, cellular phones and PDAs (Portable Digital Assistant) have been used widely, and thus the USB connector has been miniaturized.

This miniature USB connector is approximately ⅛ the size of a conventional USB connector. Because of this small size, it is highly desirable for use in portable electronic equipment. This connector has five terminals, in which an ID terminal for identification of host equipment is assembled in addition to conventional signal lines.

Currently, there are two forms of miniature USB type connectors, called an “A” type and a “B” type, or also known as a Mini-A USB connector or Mini-B USB connector. In addition, a Mini-AB USB connector, which is the latest series of USB regulation, a plug connector of either of A type and B type is inserted into a receptacle connector mounted on a board side. It was found that, at this time, in order to judge whether A type or B type plug connector is inserted, the correlation of fourth and fifth pins is set as follows. The A type has a structure of short-circuiting the fourth pin and the fifth pin for electrical judgment, whereas the B type is set for judgment by a structure in which the fourth pin and the fifth pin are not short-circuited.

FIGS. 12(a) and 12(b) show known methods of short-circuiting the fourth pin and the fifth pin. In the case of FIG. 12(a), the structure is such that terminal connection regions 304 and 305 corresponding to the fourth pin and the fifth pin of the connector 300 are short-circuited by soldering a separate conductor 310. A conductor 302 of the cable 301 is connected to either of the connection regions 304 and 305.

In the case of FIG. 12(b), the structure is such that a conductor 302 of the cable 301 to be connected is distributed and connected to the fourth pin and the fifth pin for short-circuit.

However, if these methods are adopted, the following problems occur. In the method using the separate conductor 310, a soldering step is added, a cost and the like for preparation of the separate conductor is added, and therefore problems occur in view of both the required number of steps and the cost. In the method of distributing and connecting the conductor, a dedicated soldering step, a distributing work for the conductor and the like are necessary, which is a problem.

### OBJECT AND SUMMARY OF THE INVENTION

Accordingly, an object of the present invention is to provide a technology of a connector, in which, without the increase of the number of existing manufacturing steps and the need of other parts, short-circuiting between terminals can be realized considerably efficiently, thereby enhancing productivity remarkably.

A miniaturized connector according to the present invention preferably includes five terminals each corresponding to a first pin to a fifth pin, although a number of pins more or less than five may be selected by the connector designer, an insulation housing for holding these terminals, a shield for covering the housing, and a continuous portion for electrically connecting the terminals corresponding to the fourth pin and the fifth pin to each other. Each of the terminals is preferably formed by punching a metal plate, and the continuous portion is formed of a part of the metal plate, which has been remained during a punching process of each of the terminals, although other terminal manufacturing methods may be employed.

According to the present invention, the continuous portion for short-circuit between both the terminals is formed as a part of the metal plate which remains during the punching, or other manufacturing, process for both the terminals, and therefore a new step of forming the continuous portion is not required. Consequently, the formation of the continuous portion can be realized extremely efficiently without the increase of the number of the existing manufacturing steps and the need of other parts. Due to this, the productivity can be remarkably enhanced. Further, the soldered portion is not increased, so that a structure in which a factor that may lower the connection reliability, lower the electric performance, or the like is not added, can be provided.

As to the above-mentioned terminal, it preferably includes a contact region contacted with and thus electrically connected to a terminal of a mating connector, a connection region connected to a cable, an expansion region, formed between the contact region and the connection region, for adjusting a distance between the connection regions, and the continuous portion formed in the expansion region. The contact region also serves as a portion that is force-inserted and thus mounted to a mounting portion of the housing. With this structure, the position of the continuous portion can be set at such a portion that is almost free from restriction during both the manufacturing process of the terminal and the mounting process to the housing.

It is preferable to form an operation portion between the continuous portion of the above-mentioned terminal and the contact region, which are used to mount the terminals to the housing by force-insertion operation by an automatic machine. The operation portions are used during simultaneous force-insertion of the plural terminals by being caught by comb-like teeth of the automatic machine. Since the operation portions are formed between the continuous portion of the terminals and the contact region, it can be considered that the existence of the continuous portion should not affect the operation portions.

It is preferable that the expansion region of each of the above-mentioned terminals and the continuous portion are provided on substantially the same plane with respect to the housing. In the case in which the expansion region of the terminal and the continuous portion are provided on the same plane as described above, it can be considered that the existence of the continuous portion should not affect the function of the expansion region. That is, the expansion region has the distance adjusting function between the connection regions, and, by disposing also the continuous portion on the same plane, no change is given to the distance adjusting function. For example, in the case in which the continuous portion is bent in a level difference direction, the expansion region does not exist on the same plane as the continuous portion, and consequently a change occurs in the distance between the connection regions.

Around a boundary between the expansion region of each of the above-mentioned terminal and the connection region, there may be provided a raised portion for forming a level difference between the expansion region and the connection region in a thickness direction of the terminal. This is because, since available terminals are provided with this level difference, at least a part of the terminals may be used as it is, as the terminal of the present invention.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a series of diagrams showing an embodiment of the present invention, in which a part (a) is a plane view, a part (b) is a side view and a part (c) is a bottom view.

FIG. 2 is a series of diagrams showing the embodiment of the present invention in which a part (a) is an end surface view of a plug connector 1A shown in FIG. 1, and a part (b) is an end surface view of a plug connector 1B.

FIG. 3 is an explanatory view showing a circuit diagram of the USB connector according to another embodiment of the present invention.

FIG. 4 is a partially omitted plane view of an A-type plug connector according to the embodiment of the present invention.

FIG. 5 is a partially omitted sectional view of a B-type plug connector according to the embodiment of the present invention.

FIG. 6 is a plane view of a terminal provided with a carrier according to the embodiment of the present invention.

FIG. 7 is a side view of the terminal provided with the carrier according to the embodiment of the present invention.

FIG. 8 is a series of diagrams showing the embodiment of the present invention, in which a part (a) is a partially enlarged view of FIG. 6, and a part (b) is a partially enlarged view showing an example in which a continuous portion between terminals is provided.

FIG. 9 is an enlarged view of a major part for explaining effect according to the present invention.

FIG. 10 is a sectional view of a receptacle connector.

FIG. 11 is a sectional view showing a state in which the plug connector is connected to the receptacle connector.

FIG. 12 is a series of diagrams showing a general idea of short-circuiting terminals, in which a part (a) is a perspective view of one idea, and a part (b) is a perspective view of another idea.

### DETAILED DESCRIPTION OF THE ILLUSTRATED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

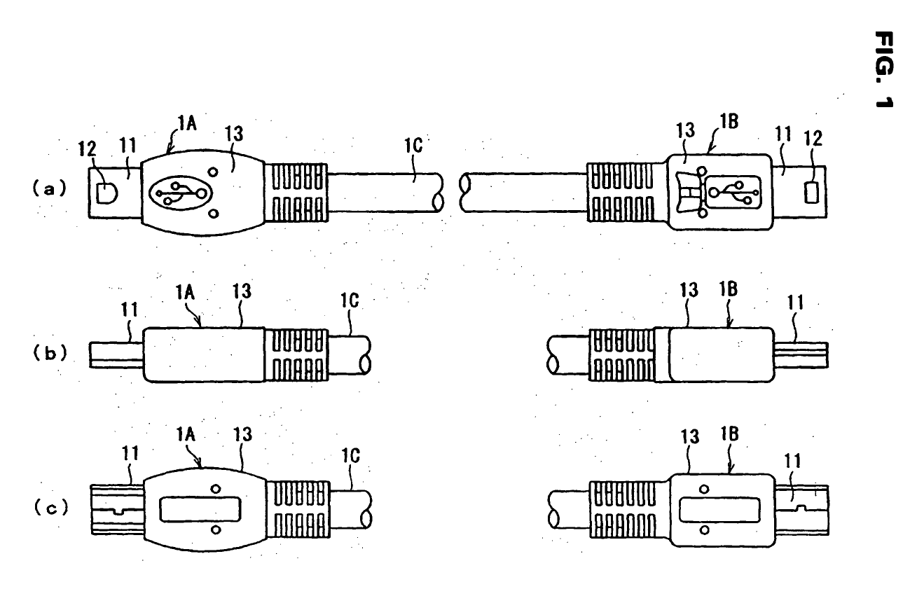

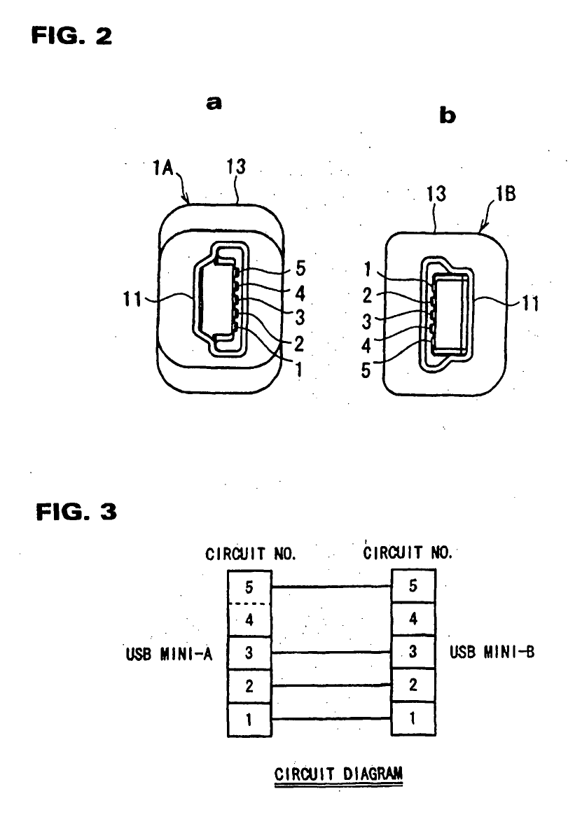

Hereafter, an embodiment of the present invention will be described with reference to FIGS. 1 to 11. FIG. 1(a) is a plane view showing an embodiment in which an A type plug connector 1A is provided on one end side of a cable 1C, and a B type plug connector 1B is provided on the other end side thereof. FIG. 1(b) is a side view of each plug connector 1A, 1B with a portion of the cable 1C being omitted, and FIG. 1(c) is a bottom view thereof. FIG. 2(a) is an end surface view of the plug connector 1A shown in FIG. 1, and FIG. 2(b) is an end surface view of the plug connector 1B shown in FIG. 1. Each plug connector 1A, 1B is called a Mini-A USB connector or Mini-B USB connector.

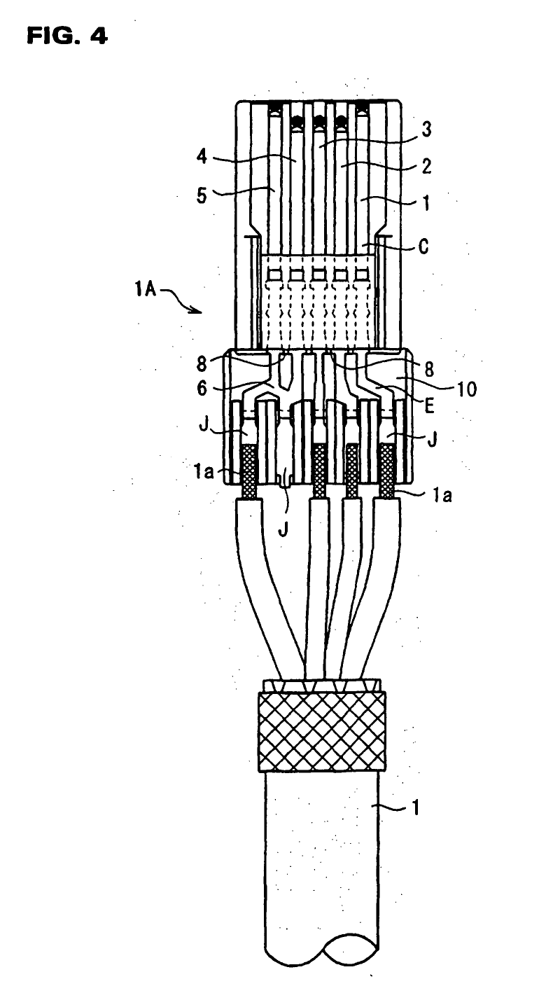

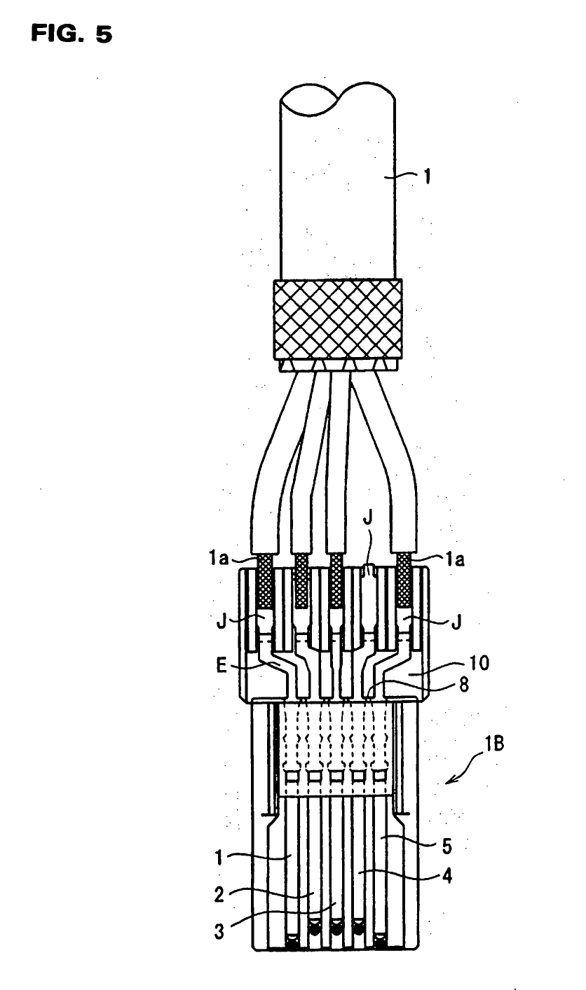

Plug connector 1A, 1B according to the embodiment includes, as shown in FIGS. 4 and 5, five terminals 1 to 5 corresponding to first to fifth pins, an insulation housing 10 holding these terminals 1 to 5, and a shield 11 made of electrically conductive metal for covering the housing 10. Each of the terminals 1 to 5 are preferably formed by punching a metal plate similarly to the available ones.

However, as to the A type plug connector 1A, the terminals 1 to 5 differ in that both the terminals 4 and 5 corresponding to the fourth and fifth pins are connected to each other through a continuous portion 6 for electrical short-circuit. This continuous portion 6 is formed of a part of the metal plate which remains during the punching process for the terminals 4 and 5 corresponding to the fourth and fifth pins. In FIG. 1, reference numeral 12 denotes a recessed portion for locking with a mating connector (a receptacle connector) 1R. A part of the shield II and the housing 10 are covered by an insulation cover 13. As shown in FIGS. 2(a) and 2(b), the shield 11 forms a mouth portion to be inserted into a receiving portion of the mating connector.

FIG. 3 is a view showing a circuit diagram of this USB connector. As shown in this figure, in both the cable connectors 1A and 1B, the corresponding pairs of the terminals of first to fifth pins shown by the circuit numbers are electrically connected to each other with the exception of the fourth pins. In the plug connector 1A which is the USB Mini-A type, the terminals 4 and 5 are electrically short-circuited to each other through the continuous portion 6 as described above. In the plug connector 1B which is the USB Mini-B type, the terminals 4 and 5 are not short-circuited to each other. In this FIG. 3, the short-circuit between the terminals 4 and 5 is shown by a broken line.

The plug connector 1A is specifically shown in FIG. 4, and the plug connector 1B is shown in FIG. 5. In FIG. 4, the five terminals 1 to 5 are mounted to the housing 10.

As shown in FIGS. 4 to 11, each of the terminals 1 to 5 has a contact region C to be contacted with and electrically connected to a terminal T of the mating connector (the receptacle connector) 1R, a connection region J connected to a conductor 1a of the cable 1C, and an expansion region E, formed between the contact region C and the connection region J, for adjusting a distance between the connection regions J. The contact region C serves also as a part which is to be force-inserted into and mounted with respect to a terminal mounting portion of the housing 10.

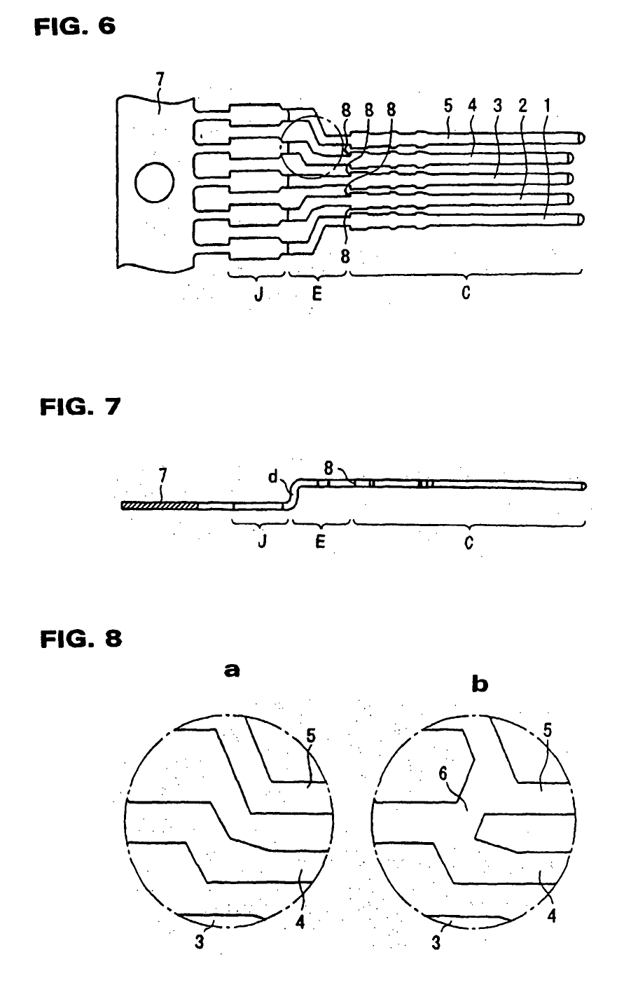

As shown in FIG. 6, the expansion region E of the central terminal 3 has a straight shape, whereas the expansion regions E of the terminals 2 and 4 and the terminals 1 and 5 positioned outside of the terminal 3 are curved outwardly. The curved amount of the expansion region E of the outermost terminal 1, 5 is larger than the curved amount of the expansion region E of the inner terminal 2, 4. With this arrangement, each distance between each of the connection regions J is kept constant. In FIG. 6, an example is shown, in which the terminals 1 to 5 are held by a carrier 7 for the purpose of simultaneous mounting with respect to the housing.

Further, in this embodiment, as shown in FIGS. 4 and 8(b), the aforementioned continuous portion 6 is formed in the expansion region E. This continuous portion 6 is for electrically short-circuiting the terminals 4 and 5 adjacent to each other, and is formed of the metal plate used during the manufacture of both the terminals. In FIG. 6, an example is shown, in which this continuous portion 6 is not provided (see FIG. 8(a)). Therefore, the exemplified terminal shown in FIG. 6 is applied to the plug connector 1B which is the B type.

Of course, as shown in FIG. 8(b), the terminal provided with the continuous portion 6 is applied to the plug connector 1A which is the A type. The width of the continuous portion 6 is substantially the same as the width of the expansion region E of the terminals 4, 5. With this structure, it is considered that the position of the continuous portion 6 can be set at such a portion that is almost free from restriction during manufacturing process of the terminal and mounting process to the housing.

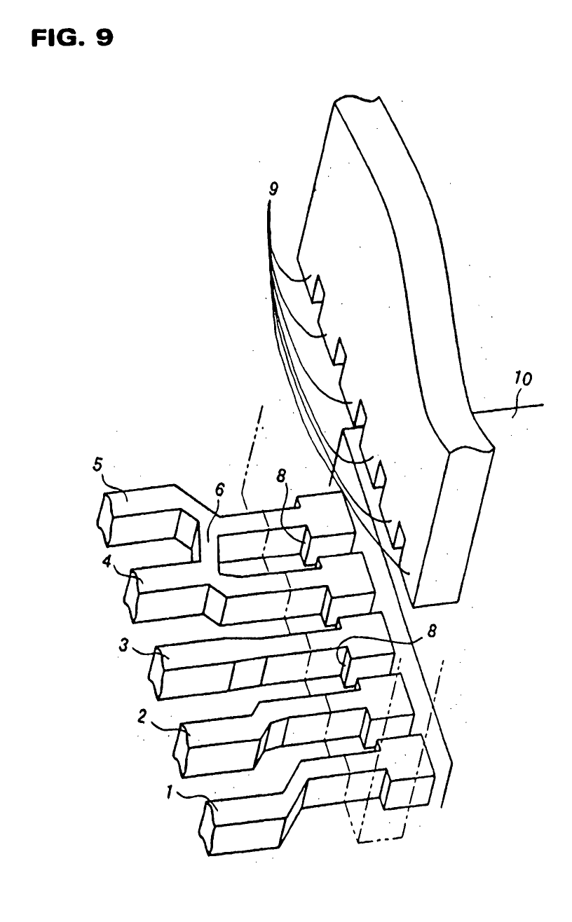

That is, a plurality of operation portions 8 are formed as one row between the continuous portion 6 of the terminals 4, 5 and the contact region C, which are used to mount the terminals 1 to 5 to the housing 10 by force-insertion operation by an automatic machine. As shown in FIG. 9, the operation portions 8 are used during simultaneous force-insertion of the plural terminals 1 to 5 by being caught by comb-like teeth 9 of the automatic machine. Since the operation portions 8 are formed between the continuous portion 6 of the terminal and the contact region C, it is considered that the existence of the continuous portion 6 should not affect the operation portions 8.

The expansion portion E of each of the terminals 1 to 5, and the continuous portion 6 are disposed on substantially the same plane with respect to the housing 10. This is because, by disposing the expansion portion E of the terminal and the continuous portion 6 on the same plane, it is considered that the existence of the continuous portion 6 should not affect the function of the expansion portion E. That is, the expansion portion E has a distance adjusting function between the connection regions J, and by disposing also the continuous portion 6 on the same plane, no change is given to the distance adjusting function. This is because, for example, in the case in which the continuous portion 6 is bent in a level difference direction (in a thickness direction of the terminal), the expansion region E does not exist on the same plane as the continuous portion 6, and consequently a change occurs in the distance between the connection regions J.

As shown in FIG. 7, around a boundary between the expansion region E of each of the terminals 1 to 5 and the connection region J, there is provided a raised portion d for forming a level difference between the expansion region E and the connection region J in the thickness direction of the terminal. Since available terminals are also provided with a level difference created by this raised portion d, at least a part of these (terminals 1 to 3) can be used as it is, as the terminal of the present invention.

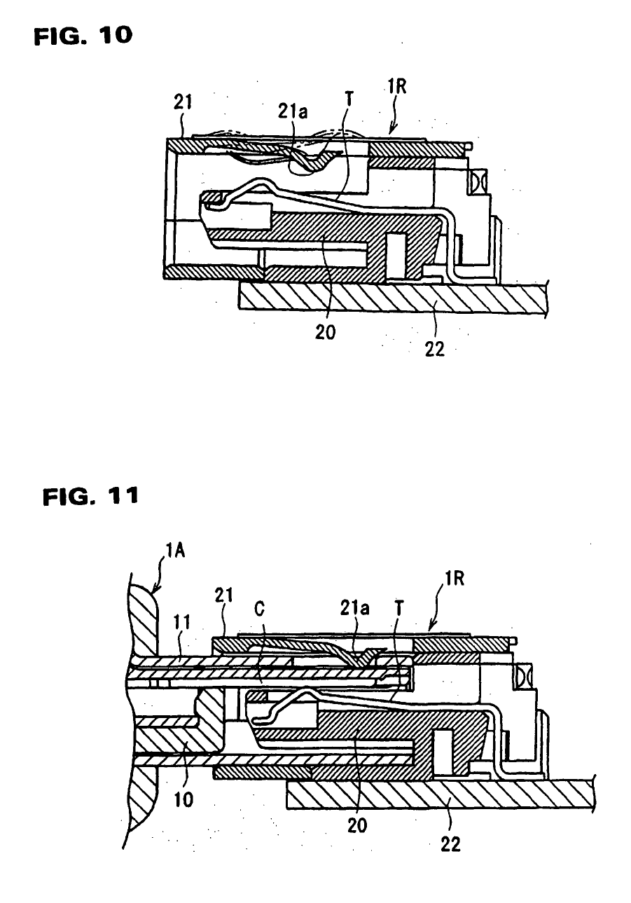

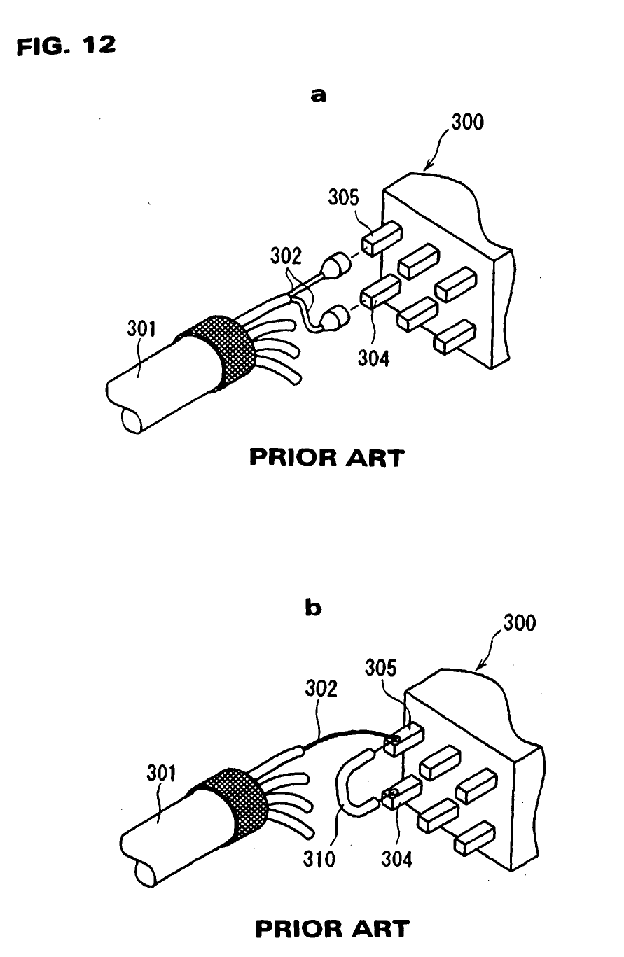

FIG. 10 is a sectional view of the receptacle connector 1R. This receptacle connector 1R is so structured as to be able to receive both of the A type plug connector 1A shown in FIG. 4 and the B type plug connector 1B shown in FIG. 5. This receptacle connector 1R has a housing 20, a plurality of terminals T mounted within the housing 20, and a shield 21 covering the housing 20. Five terminals T are provided correspondingly to the plug connectors 1A and 1B.

The shield 21 forms a mouth portion of the receptacle connector 1R which can be mounted, for example, on a circuit board or other circuit substrate. This mouth portion is formed with an elastic hook 21a. This hook 21a is designed to be insertable into the recessed portion 12 formed in the mouth portion of the plug connectors 1A, 1B. Accordingly, the hook 21a and the recessed portion 12 constructs a locking mechanism for preventing inadvertent removal of the plug connector from the receptacle connector. Further, they provide a connection function between the shields 11 and 21.

FIG. 11 is a sectional view showing a state in which the plug connector 1A is inserted and thus connected to the receptacle connector 1R. As shown in this figure, each of the terminals 1 to 5 of the plug connector 1A is contacted with a corresponding terminal T of the receptacle connector 1R. Therefore, the equipment side, where the receptacle connector 1R is mounted, electrically detects whether the terminals 4 and 5 are short-circuited or not, to thereby judge which one of the plug connectors of A or B type is connected to the receptacle connector 1R.

In this embodiment, the continuous portion 6 for short-circuit between both the terminals 4 and 5 is formed as a part of the metal plate which remains during the punching process for both the terminals 4 and 5, and therefore a new step of forming the continuous portion 6 is not required. Accordingly, the formation of the continuous portion 6 can be realized extremely efficiently without the increase of the number of the existing manufacturing steps and the need of other parts. Due to this, the productivity can be remarkably enhanced. Further, the soldered portion is not increased, so that a structure in which a factor that may lower the connection reliability, lower the electric performance, or the like is not newly added, can be provided.

In addition, although in the embodiment an example is shown, in which the continuous portion 6 is provided in the expansion region E, the invention is not limited to this, and for example, the continuous portion 6 can be provided in the connection region J. Further, it may be provided in the contact region C close to the boundary to the expansion region E. Additionally, although the illustrated embodiment refers to a USB type connector, the invention is not limited to use is USB type connectors, but, rather, can be used in any type connector wherein such a novel and simplified manner of short circuiting terminals is desired.

While a preferred embodiment of the present invention is shown and described, it is envisioned that those skilled in the art may devise various modifications of the present invention without departing from the spirit and scope of the appended claims.

1. A connector comprising:
five terminals formed by punching a metal plate, each of the terminals corresponding to a first pin to a fifth pin;
an insulation housing for holding each of the terminals;
a continuous portion, which is formed from a part of the metal plate remained during a punching process for each of the terminals, for electrically connecting the terminals corresponding to the fourth pin and the fifth pin to each other.

2. The connector according to claim 1, wherein each of the terminals include a contact region for mating with a terminal of a mating connector, a connection region for connecting to a cable, an expansion region, which is formed between the contact region and the connection region, for adjusting a distance between the connection regions, the continuous portion being formed in the expansion region.

3. The connector according to claim 1, wherein an operation portion is formed between the continuous portion and the contact region of each of the terminals, for mounting the terminal to the housing by a force-insertion operation.

4. The connector according to claim 1, wherein the expansion region and the continuous portion of each of the terminals are provided on substantially the same plane with respect to the housing.

5. The connector according to claim 2, wherein a raised portion is provided, around a boundary between the expansion region of each of said terminal and the connection region, for forming a level difference between the expansion region and the connection region in a thickness direction of the terminal.

6. The connector according to claim 1, including a shield about at least a portion of the housing.

7. An electrical connector, comprising:
a plurality of terminals;
an insulation housing for holding each of the terminals;
a continuous portion, which is formed during the manufacture of the terminals, for electrically connecting at least two of the plurality of terminals to each other.

8. The connector according to claim 7, wherein each of the terminals include a contact region, a connection region, and an expansion region located between the contact region and the connection region.

9. The connector according to claim 8, wherein the continuous portion is formed in the expansion region.
